(19) United States
(12) Patent Application Publication
(10) Pub. No.: US 2025/0224825 A1
(43) Pub. Date: Jul. 10, 2025

(54) INDUCTIVE TOUCH SCREEN

(71) Applicant: AZOTEQ HOLDINGS LIMITED, Nicosia (CY)

(72) Inventors: Frederick Johannes BRUWER, Paarl (ZA); Frederick Johannes BRUWER, JR., Paarl (ZA)

(21) Appl. No.: 19/016,097

(22) Filed: Jan. 10, 2025

(30) Foreign Application Priority Data
Jan. 10, 2024 (ZA) 2024/00331

(51) Int. Cl. G06F 3/041; G06F 3/01; G06F 3/046; G06F 3/0488

(52) U.S. Cl. CPC G06F 3/04142; G06F 3/016; G06F 3/0412; G06F 3/04186; G06F 3/046; G06F 3/0488

(57) ABSTRACT

A touch screen or a touch non-display panel based on a user touch selection interface, based on inductive force sensing without requiring capacitive touch sensing, is described. This invention offers cost advantages and will operate well and unaffected with liquids on the surface or when a user wears gloves in comparison with capacitive touch solutions. The invention also teaches to combine the implementation of force sensing and haptic signal generation.

The present application claims priority from South Africa application ZA 2024/00331, filed Jan. 10, 2024, contents of which is hereby incorporated by reference into this application.

### BACKGROUND

Touch screens (capacitive) have become commonplace since the introduction of the original iPhone by Apple.

Today (circa 2024) touch screens are ubiquitous and are for example used for controlling:
ATM's
Home security systems
Ticketing
Vending machines
Access control
Numerous kitchen/home devices (coffee machines, deep fryers, air fryers etc.)
Personal care products
Fitness trackers
Smart watches
GPS devices

Although capacitive touch offers great resolution and an easy to use interface, capacitive touch screens do have some drawbacks as well. It is quite expensive because transparent connections (indium tin oxide-ITO) are required and, of course, wiring cables and connectors for the connections to all of the nodes. Capacitive touch switches/screens are also very susceptible to water or any liquids that can cause serious degradation in functionality.

A wet screen is hardly operable and not ideal. Even operation with a normal glove can be a problem.

### SUMMARY OF THE INVENTION

In accordance with this invention a touch screen without capacitive or resistive sensing is offered using inductive sensing force sensing technology. i.e. a force applied by the user to the screen is measured or detected using a method to measure or detect a change in inductance that is related to user pressure applied to a selected location or segment on the screen.

This means that although the screen is not fitted with capacitive or resistive sensing, a user can still press on a certain segment of the screen and the force measurement device or system connected to the screen surface can identify the location of the press using inductive (or other) force sensing measurements.

Typically, in a square or rectangular screen, sensors may be placed in the four corners of the screen and, using the measured information of force from the four corners, the position of the user-applied force to the screen surface can be calculated using triangulation methods or using information from the four (or more) sensors.

Take, for example, a coffee machine with a touch screen display offering six selections: Top Left, Top Right, Middle Left, Middle Right, Bottom Left, Bottom Right. In accordance with this invention force sensors (inductive) can be used to resolve the user selection (pressing with a digit on a selected segment) on the screen with no requirement for capacitive sensing in resolving the position of the press.

By using force sensors 6, 9, 12 or even more positions can be determined using triangulation or by the use of four force sensors. Since this invention is based purely on force measurements, the system is immune to interference from water or other fluids like beer, oil, soups etc. Even user gloves do not affect the decisions or performance at all.

In another embodiment the screen can be a non-transparent overlay i.e. the selection options are printed and, by using the force sensors, a segment where pressure is applied by a user can be determined. This is a low cost screen or panel-based user input system compared with capacitive sensing.

Although the system cannot compete with the resolution of a capacitive touch screen or a touch pad, a force sensing user interface compares favourably in terms of wet environments (kitchens, showers) and cost. No conductive patterns (e.g. ITO) are required on a glass over an LCD display, for example. The force-based selection pad also has no wear and tear as is found in resistive touch screens.

Dead areas can be created between the selection segments to ensure accurate selections and margin for error.

The method in accordance with this invention allows differentiation according to the level of pressure applied by the user on the screen. It is therefore possible to indicate a pre-selection of a specific segment under light pressure but not make a final selection before more pressure is applied that meets a minimum level of pressure.

Another popular function found in capacitive touch solutions is swiping gestures such as left, right, up or down. This can easily be replicated on a force pad without capacitive/resistive touch functions. This function may be used, for example, to choose a second screen.

If the force sensing is done using inductive measurements, exemplary implementations may include a conductive or ferrite object adjacent to an inductive coil (for example on a pcb) moving closer to such coil and influencing the inductance of the coil, or may include a conductive or ferrite object moving into a hole in a center (core) of an inductor.

In another embodiment of the invention, a decision to accept a command (press/user actuation) can be announced using light, sound or haptic feedback such as is found in other user interface solutions.

Since only a limited number of selections are targeted a template may be placed on top of the rigid surface to guide the user's finger. This will help prevent pressure points on a border between two segments. This construction can help prevent ambiguous selections in display or non-display type screens.

For non-display screen applications a membrane with printed text may be inserted below a rigid surface, or on top of it. This can be used to label the functions associated with each segment.

In another embodiment real buttons may be provided that are fitted into a frame. When pressing a button, the button exerts pressure on a solid surface (e.g. glass or a flat steel plate) below it. The force sensors in the four corners of the screen can be used to determine which button was pressed. So no electromechanical contact is required and the solid surface can be used to completely seal off the electronics below it. This is good for example for outdoor keypads.

In accordance with this invention haptic, light, sound or other feedback may be provided to the user when operating the touch screen. Apertures for light may be provided for, in the templates with logos or text.

One color or type of light (flickering or low level) may be provided to indicate to the user which segment will be activated when pressure lower than a required selection level is applied. When enough pressure is applied to make the selection decision another indication may be given. This may also be by means of haptics or sound.

In another embodiment with combined capacitive sensing and inductive force sensing in a redundant (double/cross checking) method, a situation may arise with false or spurious capacitive sensing due to liquids on the screen, or for any other reason, where the capacitive sensing and inductive sensing selection do not match. In this case the Inductive sensing alone may be used for certain selections. As an extra security measure it may be required to press a series (or another) of the selection segments to verify that the inductive selections are accurate and can be trusted without capacitive measurement correlation.

In the same way capacitive sensing may be used to verify the validity of an inductive touch measurement. False sensing may result from for example quick or strong movements. It would be especially low cost to use a few capacitive electrodes on a pcb below a non-display surface that was designed to facilitate inductive touch selections in accordance with this invention. Or a single layer of ITO may be positioned on a glass layer and connected to a capacitive sensor. This capacitive measurement can then detect touch or proximity (i.e. detect human presence even through gloves etc) that will confirm that force sensing is from a touch on the screen. Since the position is not dependent on the capacitive measurement it is more resistant to effects of liquids on the screen.

The elements used for inductive force sensing (i.e. inductors) may be used to provide the force for the haptic operation. The inductor may be used to create an electromagnet that can pull an object towards it or to repel a magnetized object. The pull operation is similar to what is found in a solenoid. To prevent too high current supply requirements on the power supply, a supply capacitor may be placed near the inductor and the sharp rise in current may be sourced from the capacitor when the current through is switched for haptic operation. This may provide a very cost effective solution for haptic implementation as the inductors used for the inductive measurements are dual purposed.

The integrity of selection can be improved by the use of software. For example, multiple thresholds may be used to decide on a pre-selection (that can also be indicated through haptics or light to the user) at a lower pressure level and then a higher pressure level is used to do the final selection. The final selection may also for example be indicated to the user with specific haptic, light or other indication means.

In a further embodiment of the invention the software may be adaptive (AI) and as such adjust the decision making levels in accordance with noise levels and other measurement information and user feedback. This will improve selection integrity over time.

If the selections to be chosen from are on a grid with a significant margin for error, the software AI can also compensate for any drift over time or temperature or even for offsets caused by mechanical changes. This means for example if the software detects that at a higher temperature the user inputs are constantly offset to the right, it can adjust in accordance with the temperature in future.

Time lapsed (a time period) may also be used to improve the quality and integrity of selections. A bump or sudden jolt of a product that includes the touch screen may cause force measurements that are similar to a user activation. However if it is required that a user must press the touch screen or panel for an extended period, it is unlikely that a bump of any kind could result in such signals. And if capacitive proximity or touch is brought into consideration, the integrity of the touch selection is very high.

The force sensing touch screen may also be implemented using other (not only inductive) force measurements.

### BRIEF DESCRIPTION OF DRAWINGS

FIG. 1 shows a screen divided into segments with dead zones;

FIG. 2a shows a typical construction (stack up);

FIG. 2b illustrates a variation in the construction of an inductive force sensor;

FIGS. 3a and 3b depict forces which are measured when a user presses in two specific segments;

FIGS. 4a to 4c show various constructions to implement combined force sensor and haptic generation;

FIG. 5 shows a non-display screen with an overlay which depicts selections and a grid to help prevent ambiguous selections, the grid is over dead zones and include an aperture for light in each selection zone; and

FIGS. 6a and 6b show a non-display inductive touch screen with mechanical keys constructed to exert pressure at specific points on the inductive touch screen.

### DETAILED DESCRIPTION OF THE INVENTION

This description is exemplary of embodiments of the invention that clarify certain concepts and implementations of the invention and is not meant to limit the scope of the invention. Many products and applications not described herein may fall under the scope of what is covered.

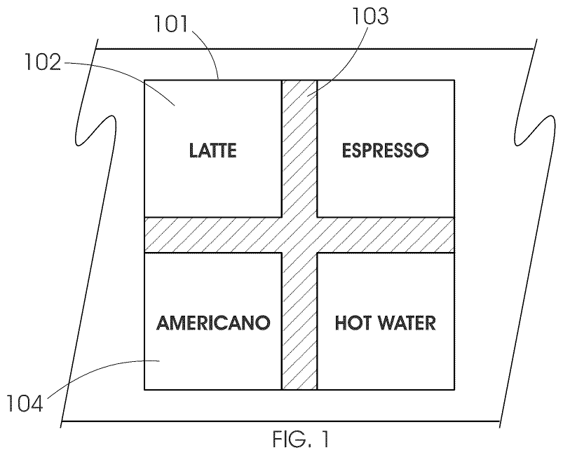

In FIG. 1 a touch screen (101) such as a touch screen found in many coffee machines is shown with selection segments indicated. When a user presses on the segment indicating “Latte” (102) the force applied by the user on the screen is measured and by combining the relative measured forces from all force sensors used with the screen the position of the press can be calculated.

The darker areas 103 are dead zones and may be used to improve selection accuracy i.e. if the user presses between “Latte” 102 and “Americano” 104 in the dead zone no selection will be made. There may optionally be a “bad selection” feedback indication to the user. Of course, the dead zones 103 are virtual areas and do not need to look any different on the display. As a pre-selection indication, upon a light press, the display may change appearance to inform the user of the selection that will be made if for example more force is exerted or if more time is allowed to pass with a force exerted. The user may in fact slide a digit from one segment to the next segment under light pressure with the appropriate segment being indicated as the digit slides over it.

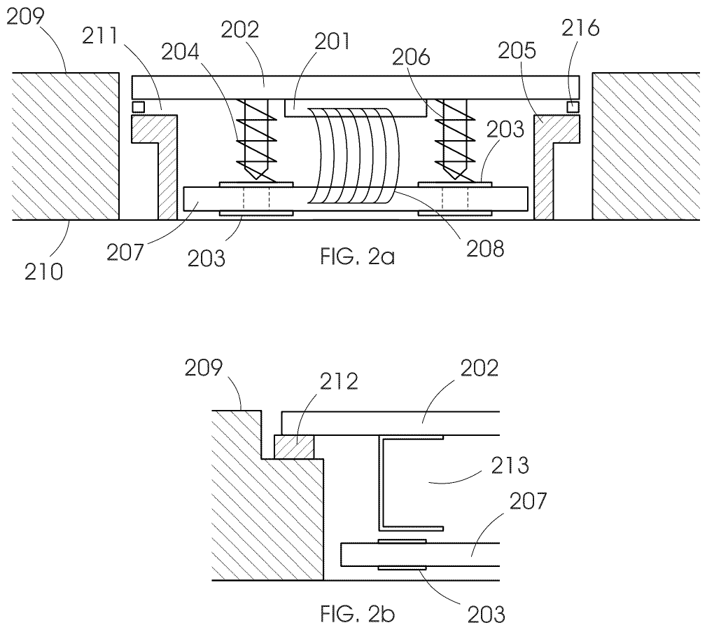

In FIG. 2a an exemplary construction is shown with a display screen 201 covered with glass 202 on top (for strength and protection) and inductors 203 positioned at four corners of the screen. The inductance is altered when a member 206 (conductive or ferrite) that is attached to the glass, moves into the center of a coil 203. A spring 204 supports the glass and is such that it does not press the display screen out of the product housing 209. The only points of support for the screen/glass 202 are in the four corners where force exerted by the user is countered by the springs but resulting in small movement taking the members 206 closer to the inductors. Depending on the position of the press the different corners experience different displacements that can be measured and used to calculate the position of the press.

A flexible sealing ring 216 may be used to seal the underside 211 or even the sides of the top layer 202, but this must be such that a user press will still result in the glass moving under the pressure exerted by the user i.e. compressing such seal ring or other sealing mechanism.

The coils 203 may be part of a pcb 207. The display is connected to the pcb with a ribbon cable or flex pcb 208. Stops 205 are mounted on a base 210 of the product and can be all around the unit. A gap 211 between the stops 205 and the glass 202 may be filled with a compressible material or glue that can help seal the inside from the outside and may keep the display screen in place.

In FIG. 2b the housing 209 is shaped to provide the stop function. The only spring effect is provided by the compressible material 212 between the housing 209 and the glass 202.

The change in inductance is induced by a member 213 that is firmly attached to the glass 202 and that moves closer to the inductive coil 203 when pressure is exerted on the glass 202, for example when a user wants to select a function by touching on the glass.

The attached drawings are not to scale, and dimensions in the drawings have been chosen to clearly demonstrate the concepts and implementations of the invention. For example, the spring 204 will be much stronger in practice to limit the movement under user actuation. The gap 211 before stopping will be much smaller, than what is shown.

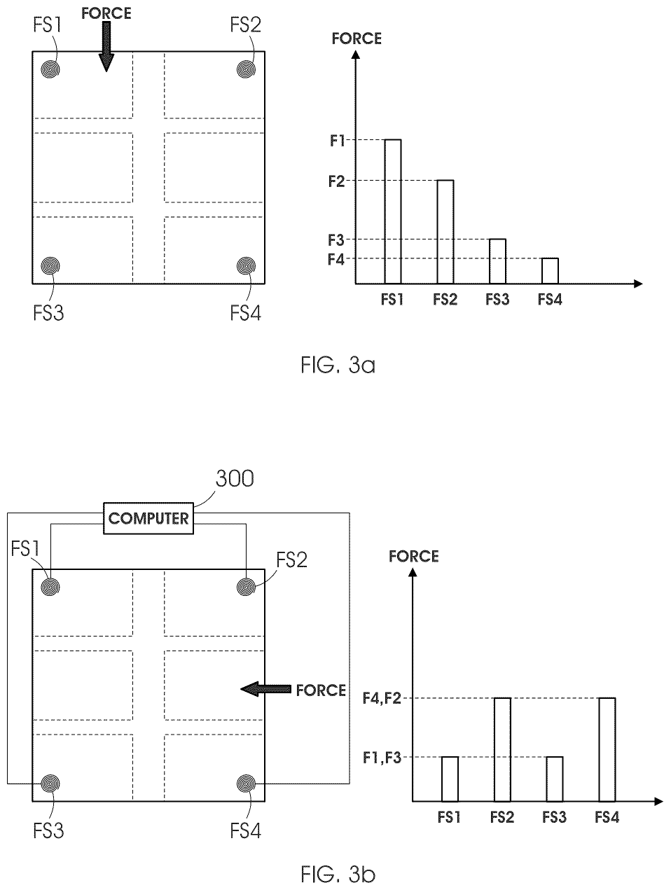

In FIG. 3a a screen according to this invention and designed with 3×2 segments is shown. Pressure is applied by an object in the left top position. The relative forces measured in the four corners are shown.

In FIG. 3b the same screen and measured forces are shown when pressed in the middle right position.

This is exemplary and although many more positions can be shown the concept is clear. The position of the press is calculated using the forces measured at the points of support. When only two points of support exist there is only information to determine the position in one dimension. Triangulation can be used for three points of support. For more than 4 points the mathematics becomes more complex but may be worthwhile to achieve increased accuracy. A mechanism, e.g. a suitably programmed processor or computer 300, can readily determine the position on the screen, at which force was applied, by using the force measured from the respective screen corners.

The seal ring 216 may also introduce an effect where a press of a specific amount of pressure in the center of the screen causes a change in the measured inductance at all four corner sensors but these changes will not add up to the same pressure movement/inductive change when that same specific force is exerted right above a sensor. However, with a stable/consistent flexibility in the seal ring this effect can be calibrated out to compensate for this effect.

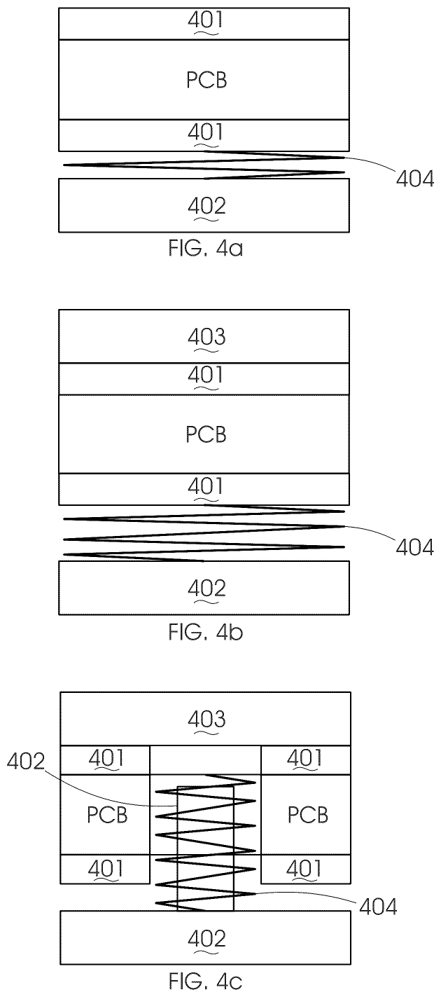

In FIGS. 4a, 4b and 4c the construction of a combined haptic generator and inductive force sensor is shown. An inductive coil 401 is made on a pcb which may be multi-layered. On one side a magnetically permeable member 402 is located adjacent to the coil 401. The construction is such that pressure on the pcb or coil 401 will move it closer to the member 402. The resultant change in distance between the member 402 and the coil 401 is reflected in the measured inductance of the coil i.e. for a certain construction the force exerted can be calculated from the change in inductance.

In FIG. 4a when a current is passed through the inductive coil 401, the pcb and coil 401 can be pulled magnetically towards the member 402. With enough magnetically produced force the pcb and coil 401 can create a haptic effect. A spring 404 will push the member 402 away from the pcb and coil 401.

In a variation of the implementation of FIG. 4a, the member 402 can be permanently magnetised. When current is passed through the inductive coil 401, the pcb and coil 401 can be pulled magnetically towards the member 402. Or, by reversing the direction of the current through the coil 401, the pcb and the coil can be pushed magnetically away from the member 402.

In FIGS. 4b and 4c, a member 403 that is permanently magnetised is mechanically attached to the pcb and coil 401. The pcb, the coil 401 and the member 403 are pressed away from the stationary member 402 by a spring 404 or by a compressible material. When current is passed through the inductive coil 401 in one direction the member 403 can be magnetically pulled hard towards the stationary member 402. Conversely, if current is applied to oppose the permanent magnetic field, the member 403 will be pushed away from the stationary member 402 by the spring 404 and the opposing magnetic field generated by the coil 401. With enough force/mass the member 403 can create a haptic effect. Depending also on the spring the unit will exhibit a natural frequency.

The elements 403 and 402 are interchangeable in FIG. 4b.

In one variation of the embodiments of FIGS. 4b and 4c the member 403 comprises a magnetically permeable material. By using a magnetizable (low coercivity) material as the member 402 and by inducing a large instantaneous excitation, the magnetizable (low coercivity) material 402 can be semi-permanently magnetised. The effect of this is that the coil 401 and pcb, and the member 403 can be semi-permanently pulled closer to the member 402, tensioning the spring 404 or compressible material used in place of the spring.

In another variation of the embodiments of FIGS. 4b and 4c the member 403 is a permanent magnet. By using a magnetizable (low coercivity) material in the member 402 and by inducing a large instantaneous excitation, the magnetizable (low coercivity) material 402 can be semi-permanently magnetized. The magnetisation polarity can be controlled by the direction of the current flowing through the coil 401. The effect of this is that the coil 401 and pcb, and the member 403 can be semi-permanently pulled closer to the member 402, or repelled from the stationary member 402, respectively tensioning or de-tensioning the spring 404 or the compressible material (when used).

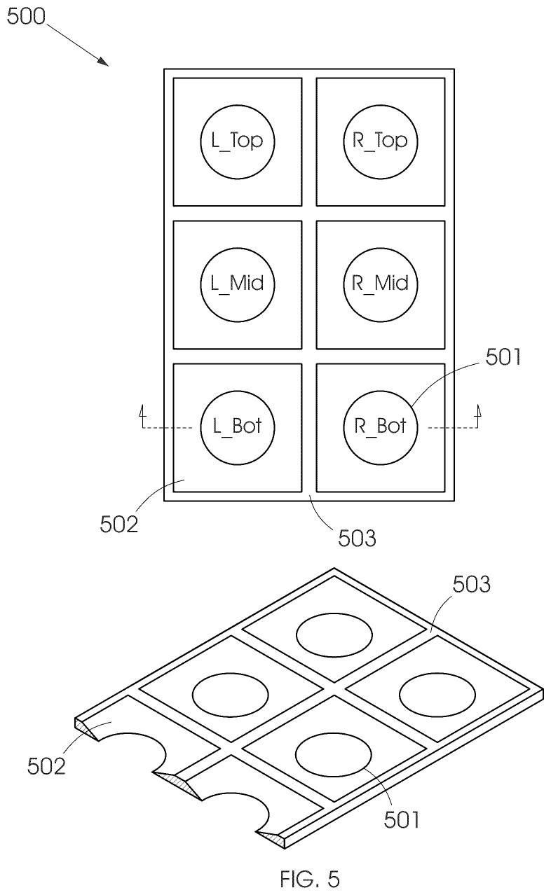

FIG. 5 shows a non-display touch screen 500 with a template 502 comprising a glass overlay and a layer of printed material designating the functions associated with each position on the touch screen. The printed layer may be above or below the glass layer and does not affect the movement of the glass layer under pressure. The template 502 that is 3 dimensional with high areas 503 between selection areas or segments may be positioned above the glass layer in order to clearly guide a user to the various selections. A middle area 501 in each segment is open (i.e. no material). Thus the user will press directly on the touch screen when in the right position. The dead zones 503/502 are implemented to make sure any touch that is not in an opening 501, is ignored.

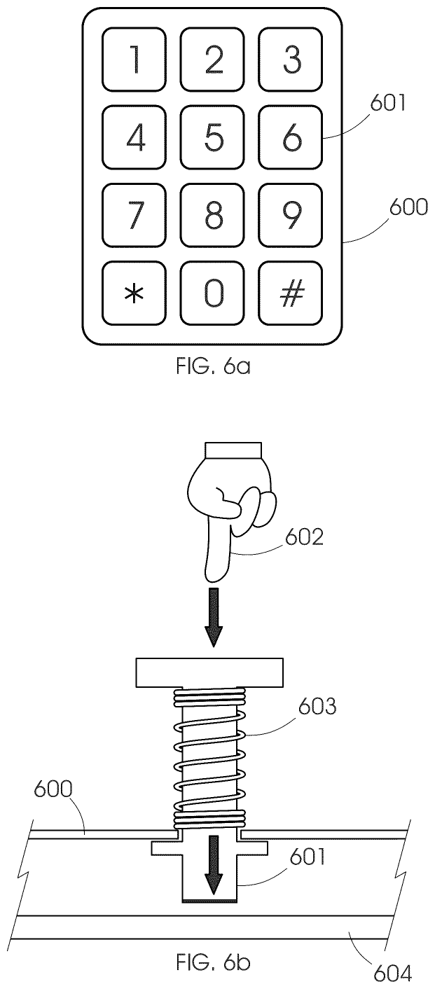

In FIG. 6a mechanical buttons 601 are positioned within a frame 600. When a button is pressed by a user it simply presses down on the top solid layer. This is illustrated in FIG. 6b where the button structure 601 is positioned in the frame 600 with a spring 603 pushing the button outwards. A user press 602 downwards on the button 601, which overcomes the force of the spring 603, causes the member 601 to push onto the force touch layer 604 and act on a chosen segment of the screen, corresponding with a button. Since the user can now only exert force on the top layer (i.e. through the buttons and not directly with a finger) adaptive algorithms can more easily be implemented to adjust for drift over time or other factors influencing the derived position from the measured inductors in the corners. There are still no ohmic contacts required.

The button construction is exemplary and only depicts a concept of the invention. With the embodiment in FIGS. 6a, 6b an activating force can only be exerted at very specific positions on the force screen layer 604, which can seal off the rest of the product.

Through the use of the correct materials the current invention provides an ideal solution for keypads that are exposed to all elements.

1. A method of implementing a touch selection on a force touch screen which is supported by a plurality of force sensors on a structure, the method comprising the step of calculating a position of a touch on the screen from measurements of forces which are produced by the sensors and which are caused by the touch.

2. The method according to claim 1 wherein the force sensors are inductive force sensors.

3. The method according to claim 2 which includes the step of using consecutive positional results to identify swipe gestures.

4. The method according to claim 2 which includes the step of using the said plurality of inductive force sensors and the said structure for said force measurements and for haptic signal generation, and wherein the touch screen does not use capacitive or resistive sensing technology to determine said touch position.

5. The method according to claim 4 which includes the step of using time lapsed to increase the integrity of selection decisions.

6. The method according to claim 2 which includes the step of using adaptive (AI) software to improve quality of selections over time.

7. The method according to claim 2 which includes the steps of positioning buttons which respectively correspond with segments on the force touch screen and wherein, when a selected button is pressed the button acts on the associated segment of the force touch layer of the force touch screen.

8. A force touch screen comprising multiple force sensing structures that are positioned to allow the determination of a user press position in an area of the screen within a perimeter of the said force sensing structures by using data derived from the force sensing structures in response to a user press on the screen.

9. The force touch screen in accordance with claim 8 wherein the screen also comprises a display.

10. The force touch screen in accordance with claim 8 wherein displacement of the screen is determined using inductive measurements from said force sensing structures.

11. The force touch screen in accordance with claim 10 wherein said force sensing structures are used to determine said user press positions and also to generate a haptic signal that can be perceived by the user touching the force touch screen.

12. A touch screen apparatus which includes a touch screen with a plurality of segments each of which denotes a particular selection, a support structure, a plurality of spaced apart force sensors which are mounted to the support structure and which are responsive to movement of the touch screen resulting from a touch selection on the touch screen by a user, whereby each sensor produces a respective signal which is representative of the force which is thereby applied to the sensor, and a mechanism for detecting the position of the touch on the touch screen and hence the particular segment selected, from the force measurements of the sensors.
